(19) United States
(12) Patent Application Publication
(10) Pub. No.: US 2006/0156835 A1
(43) Pub. Date: Jul. 20, 2006

(54) Housing with reduced thermal, conduction for a measuring instrument

(75) Inventors: Alexander Mueller, Sasbach-Jechtingen (DE); Gottfried Hintner, Schopfheim (DE); Helmut Pfeiffer, Steinen (DE)

Correspondence Address: Bacon & Thomas, 4th Floor, 625 Slaters Lane, Alexandria, VA, 22314-1176, US

(73) Assignee: Endress + Hauser GmbH + Co., KG, Maulburg (DE)

(21) Appl. No.: 10/535,912

(22) PCT Filed: Nov. 20, 2003
(86) PCT No.: PCT/EP03/12982

§ 371 Date: Jan. 27, 2006

(30) Foreign Application Priority Data
Nov. 23, 2002 (DE) 102 54 720.3

(51) Int. Cl. G01D 3/036

(52) U.S. Cl. 73/866.5

(57) ABSTRACT

A measuring device is provided, which is usable at high temperatures. The device includes: a housing, which has a first section, on which a means is provided for securement of the housing to a measurement location; a second section, which borders on the first section; and a third section, which borders on the second section and which contains electronic components. The second section is constructed such that, in the case of a temperature difference between an environment of the first section and an environment of the third section, a small heat flow flows through the second section parallel to a longitudinal axis of the housing.

The invention relates to a measuring device with a housing, in which electronic components are arranged.

Measuring devices are used in almost all branches of industry for registering physical quantities, e.g. fill levels or pressures.

Measuring devices usually have a section for registering the physical quantity. In the registering section, the physical quantity is converted into an electrical quantity and this is made available for an evaluation, processing and/or display. For all of these purposes, depending on measuring device, electronic circuits of greater or lesser complexity are provided in the measuring device. These circuits contain electronic components.

Fill level limit switches may serve as an example of a measuring device. These detect the reaching of a predetermined fill level and are used e.g. for preventing overfilling or for protection against running pumps empty.

Currently, for example, fill level limit switches are available with a pot-shaped housing, the floor of which has the character of a membrane, or diaphragm. The membrane is caused to oscillate during operation by at least one piezoelectric element arranged within the housing. Formed on the membrane are e.g. oscillation tines, which extend into the container. These tines oscillate parallel to their longitudinal axis during operation. The oscillation unit formed of the membrane and the oscillation tines is preferably excited to resonance oscillations. The resonance frequency of the oscillation unit depends on whether the oscillation tines are covered by fill substance or not. Thus, one can tell from the resonance frequency whether the oscillation tines are covered by fill substance or not. If the oscillation tines are covered by fill substance, then a predetermined fill level has been reached. The predetermined fill level is determined by the level at which the fill level limit switch is installed in the container.

Measuring devices are mounted e.g. on a container at a measurement location. In such applications, it can happen that relatively high temperatures occur in certain circumstances at the measurement location. Temperatures in closed containers in many branches of industry reach e.g. up to 150° C. Moreover, relatively high temperatures, e.g. 50° C., can arise in the vicinity of the location of measurement. Electronic components are, however, very temperature sensitive. As a rule, usual electronic components can only be used at temperatures up to a maximum of 85° C.

Depending on the kind of application and the details of the installation at the container, it can be necessary to provide a very robust housing. In many applications, the housing must be able to withstand a load of up to 1000 N transverse to a longitudinal axis of the housing, without breaking.

Metal housings are very robust and can, moreover, be cleaned well. In keeping with this, metal housings are preferably used for measuring devices in the field of industrial measurements technology.

Metals are, however, good conductors of heat. A good heat conduction through the housing brings with it the disadvantage that electronic components located in the housing experience a very pronounced warming, when high temperatures predominate at the measurement location.

It is an object of the invention to provide a measuring device which can be used also in the presence of high temperatures.

To this end, the invention concerns a measuring device having

a housing,

which has a first section,

on which a means for the securement of the housing at a measurement location is provided,

which has a second section,

which borders on the first section, and

which has a third section,

which borders on the second section and

in which electronic components are located,

wherein the second section is constructed such that, in the presence of a temperature difference between an environment of the first section and an environment of the third section, a small flow of heat flows through the second section, parallel to a longitudinal axis of the housing.

According to a further development, a wall of the second section has at least one region of reduced wall thickness.

According to a further development, at least one peripheral groove is provided in the wall of the second section.

In another further development, a plurality of regions of reduced wall thickness are arranged next to one another in the wall of the second section, separated from one another by webs.

In another further development, the wall of the second section has a plurality of levels of adjoining regions of reduced wall thickness, the levels being arranged one on top of the other, with neighboring regions of one level being separated from one another by webs, and webs of neighboring levels being offset with respect to one another.

In another further development, a support of insulating material is arranged within the housing in the region of the second section for increasing a mechanical strength of the housing relative to loads perpendicular to the longitudinal axis of the housing.

According to a further development, the wall of the second section has undulations arranged in a honeycomb pattern.

According to a further development, a plurality of peripherally extending grooves are provided in the wall of the second section, with the grooves being arranged alternatingly on an inner side of the wall and on an outer side of the wall.

The invention and further advantages will now be explained in greater detail on the basis of the figures of the drawing illustrating seven examples of embodiments; equal elements are provided in the figures with equal reference characters.

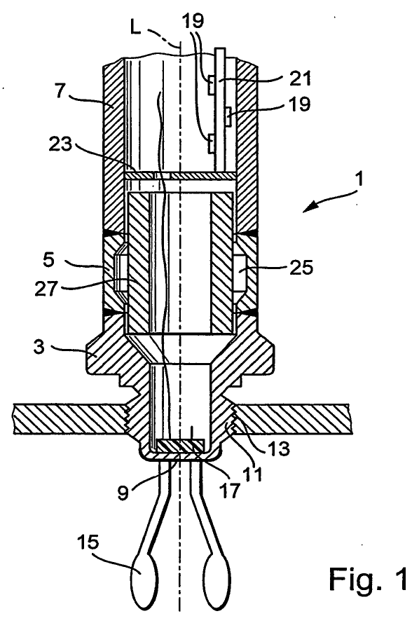

FIG. 1 shows a section through a measuring device having a peripherally extending groove;

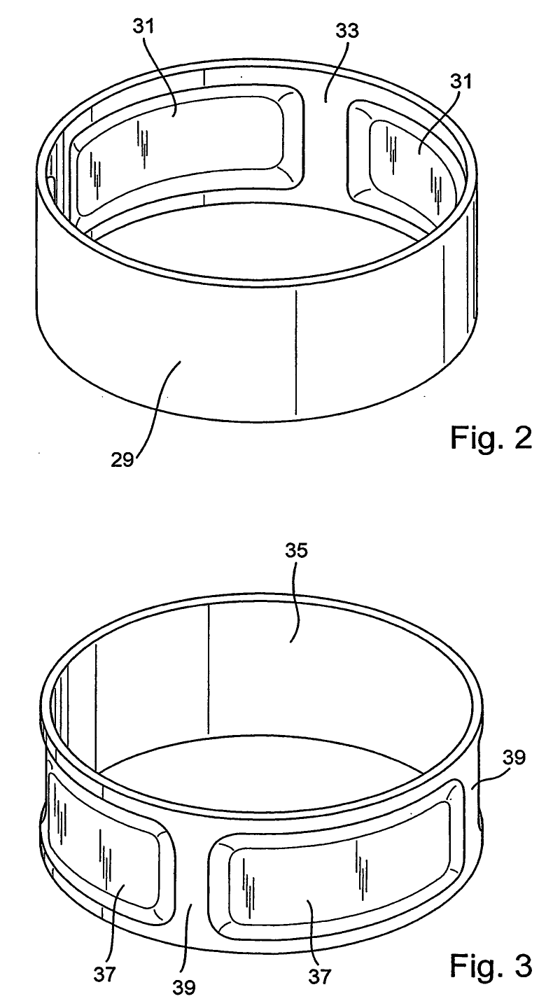

FIG. 2 shows a view of a second section having regions of reduced wall thickness arranged next to one another on an inner side of the wall;

FIG. 3 shows a view of a second section having regions of reduced wall thickness arranged next to one another on an outer side of the wall;

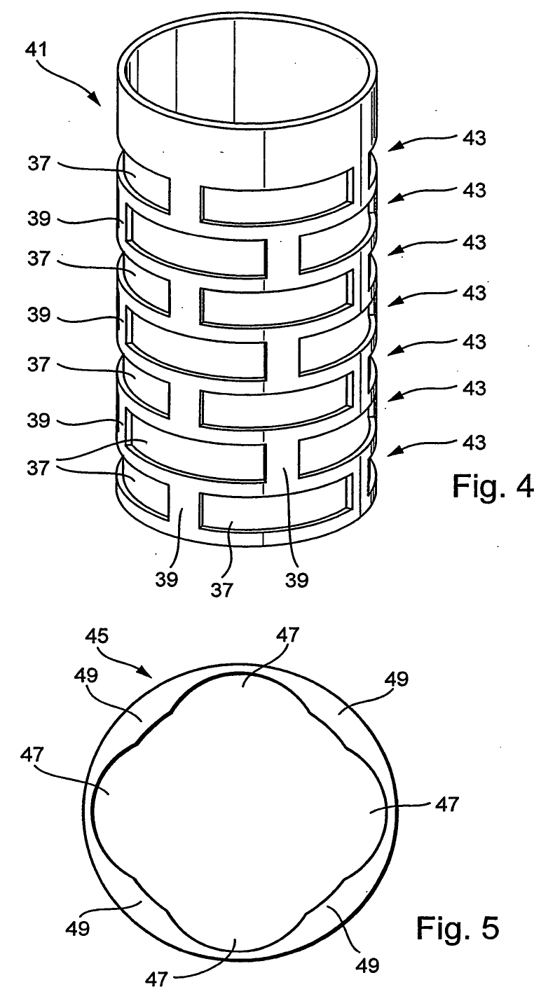

FIG. 4 shows a view of a second section having a plurality of mutually superimposed levels having regions of reduced wall thickness arranged adjoining one another on an outer side of the wall;

FIG. 5 shows a cross section through a second section having regions of lesser wall thickness formed by circular-segment-shaped recesses in the cross section;

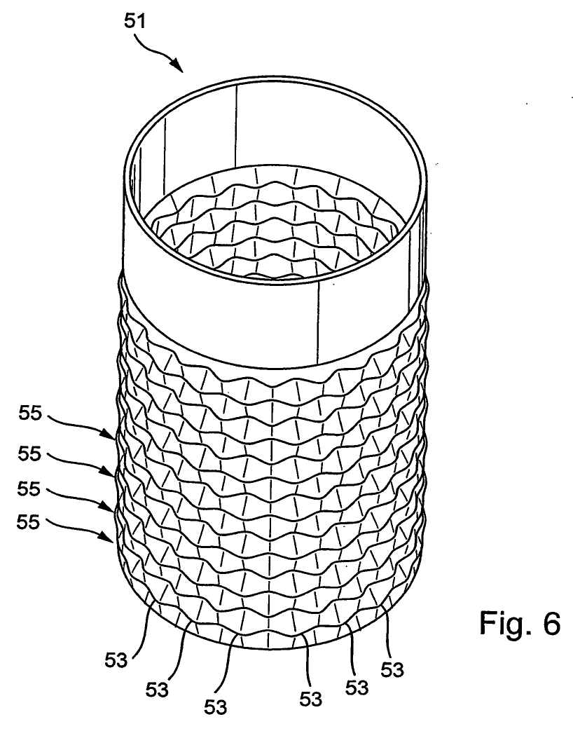

FIG. 6 shows a view of a second section undulations arranged in a honeycomb pattern; and

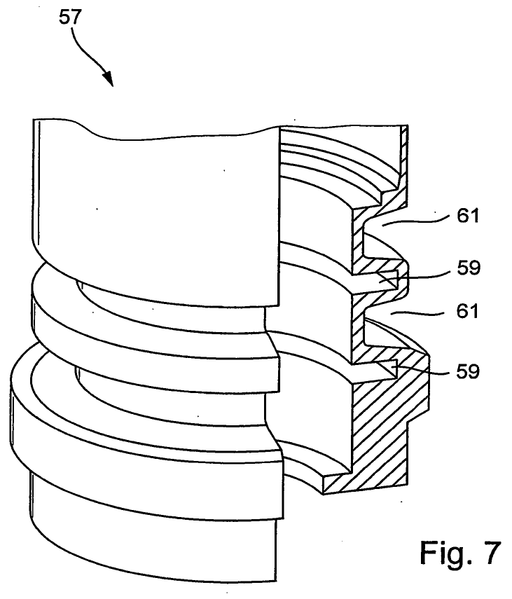

FIG. 7 shows a partially sectional view of a second section with internal and external grooves arranged alternatingly one on top of the other.

FIG. 1 shows a section through a measuring device of the invention.

The illustrated example of an embodiment involves a fill level limit switch for determining and/or monitoring a predetermined fill level in a container. Limit switches of this type are used in measurement and control technology.

The measuring device has a housing 1 of metal, e.g. stainless steel, including a first section 3, a second section 5 and a third section 7.

The first section 3 has the form of a cylinder closed on the end by a membrane, or diaphragm, 9.

The cylinder is provided with a means 11 for securement of the housing 1 at a location of measurement. In the illustrated example of an embodiment, means 11 is an external thread formed on the first section 3. The housing 1 is screwed into a matching thread at the location of measurement. In the illustrated example of an embodiment, housing 1 is screwed into an opening 13 of a container. Other means of securement, e.g. connecting flanges, are likewise usable.

Formed on membrane 9 are two mutually spaced, oscillation tines 15, which extend into the container and oscillate, during operation, with opposite phase, perpendicularly to their longitudinal axis. To this end, the face of membrane 9 directed toward the interior of housing 1 is provided, e.g. adhered thereto, with a piezoelectric element 17, by which the membrane 9 can be caused to execute bending oscillations.

During operation, the oscillation unit composed of membrane 9 and oscillation tines 15 is set into resonance oscillation and its resonance frequency is registered. If the resonance frequency lies beneath a predetermined threshold value, then the oscillation tines are covered by a fill substance in the container, and, if the resonance frequency is above the threshold value, then the oscillation tines are free of the fill substance.

Bordering on a membrane-far end of the first section 3 is the second section 5 of the housing 1. The second section 5 is likewise essentially cylindrical.

The second section 5 is constructed such that, in the presence of a temperature difference between an environment of the first section 3 and an environment of the third section 7, a low heat flow flows through the second section 5 parallel to a longitudinal axis L of the housing 1. In this way, heat transfer from the first section 3 to the third section 7 is reduced.

The third section 7 is likewise cylindrical and borders on an end of the second section 5 far from the first section 3. Electronic components 19 are located in the third section 7. In the illustrated example of an embodiment, the components 19 are arranged on a circuit board 21, which is secured in the third section 7 by means of a holder 23 only schematically illustrated in FIG. 1.

The second section 5 effects a protection of the third section 7, and of components 19 situated therein, from heat. Since the second section 5 is constructed such that, in the case of a temperature difference between the environment of the first section 3 and the environment of the third section 7, only a low heat flow flows through the second section parallel to a longitudinal axis L of the housing I, a heating of the first section, which can, under circumstances, be exposed at the location of measurement to very high temperatures, leads, as compared to conventional measuring devices, to a clearly lesser heating of the third section and the electronic components 19 located therein.

A lesser heat flow parallel to the longitudinal axis L is achievable physically in two different ways. For instance, a heat flow caused by a temperature gradient between the first action 3 and the environment of the third section 7 can be reduced by reducing a cross sectional area available for this heat flow. Or, heat given off radially outwardly from the second section 5 by convection can be increased by increasing the surface area available for such. Both possibilities, as well as a combination of both possibilities, will now be explained in greater detail on the basis of the examples of embodiments.

The cross sectional area available for the heat flow is significantly reduced by providing a wall of the second section 5 with at least one region of reduced wall thickness. The cross sectional area is proportional to wall thickness.

In the case of the example of an embodiment illustrated in FIG. 1, an annular groove 25 is provided in the wall of the second section 5, on the inner side of the wall. The smaller the wall thickness in the region of the groove 25, and the broader the groove 25, the lower is the temperature acting on the electronic components 19 in the third section 7.

A reduced wall thickness and a broad groove 25 lead to a reduction in the mechanical stability of the housing 1. Especially critical, in such case, are loads, which act on the housing 1 perpendicular to the longitudinal axis L.

Preferably, therefore, as shown in FIG. 1, a support piece 27 of an insulating material is arranged in the interior of the second section 5 for increasing the mechanical strength of the housing 1 against loads perpendicular to the longitudinal axis of the housing 1. The support piece 27 is a hollow tube, whose outer geometry is fitted to an inner geometry of the second section 5. In the case of a cylindrical second section 5, this means that an outer diameter of the support piece is preferably equal to an inner diameter of the second section 5.

Support piece 27 is made of an insulating material, because insulating material has, in comparison to metals, a low heat conductivity. The first section 3 has a lesser inner diameter than the second section 5. Between the first and second sections 3, 5, a bearing surface therefore results, against which the support piece 27 abuts.

FIG. 2 is a view of a further example of an embodiment for a second section 29. This second section 29 has in its wall, on the inner side thereof, a plurality of regions 31 of reduced wall thickness. The regions 31 are arranged adjoining one another and are separated from one another by webs 33. Regions 31 are arranged uniformly on the section 29.

The regions 31 effect a reduction of the heat flow parallel to the longitudinal axis L of the housing 1. The separation of the regions by the webs 33 provides the second section 29 with an increased mechanical stability, especially also relative to loads perpendicular to the longitudinal axis L of the housing 1.

FIG. 3 shows a further example of an embodiment of a second section 35. It differs from the example of an embodiment shown in FIG. 2 only in that the recesses providing the reduced wall thickness of the regions 37 lie not within the housing 1, but, instead, on an outside of the wall. They are likewise mutually separated by webs 39 and distributed uniformly over the section 35.

FIG. 4 shows a view of a further example of an embodiment of a second section 41. In the case of this second section 41, a plurality of levels 43 of adjoining regions 37 of reduced wall thickness are arranged one on top of the other. Also here, the neighboring regions 37 of a level 43 are separated from one another by webs 39. Advantageously, webs 39 of neighboring levels 43 are arranged offset from one another. In this way, a further reduction of the heat flow parallel to the longitudinal axis L is achievable.

FIG. 5 shows a cross section of a further example of an embodiment for a second section 45. This second section 45 exhibits four internal regions 47 of reduced wall thickness. The regions 47 are arranged to neighbor one another and are separated from one another by ring-segment-shaped webs 49. The regions 47 themselves are formed by recesses exhibiting in the cross section a circular-segment shape.

While in the case of all of the previously described examples of embodiments, the heat flow parallel to the longitudinal axis L of the housing 1 in the second sections 5, 29, 35, 41, 45 is controlled by the small cross sectional area available in such direction, in the case of the example of an embodiment of a second section 51 illustrated in FIG. 6, the wall thickness of the second section 51 is everywhere practically the same.

The wall of the second section 51 has, instead, undulations 53 arranged in a honeycomb pattern. In this instance, a plurality of layers 55 of adjoining undulations 53 are provided.

Alternatively, however, only one layer can be provided, or only regions of the wall, but not the entire wall surface, can exhibit undulations 53. The undulations 53 can be produced e.g. by explosive forming techniques.

The undulations 53 effect an increased surface area and, consequently, an increased heat loss from the housing 1 due to convection. The greater the amount of heat lost due to convection, the less the amount of heat flow in the direction of the third section 7.

Additionally, this form of embodiment offers the advantage that the honeycomb arrangement of the undulations 53 effects a greater stiffness of the housing 1 relative to mechanical loads perpendicular to the longitudinal axis of the housing 1.

FIG. 7 shows a further example of an embodiment for a second section 57. In the wall of the second section 57 of this example, a plurality of peripheral grooves 59, 61 are provided. The grooves 59, 61 are arranged parallel to one another, and one on top of another, with the grooves 59, 61 being arranged alternatingly on an inner side of the wall and an outer side of the wall, i.e. adjoining a groove 59 lying on the inner side of the wall, there is a groove 61 arranged on the outer side, which is then followed by a groove 59 arranged on the inner side of the wall.

The grooves 59, 61 effect that, exactly as in the case of the example of an embodiment illustrated in FIG. 1, the cross sectional area available for heat conduction parallel to the longitudinal axis L of the housing 1 is reduced.

Additionally, the alternating arrangement of inner and outer grooves 59, 61 leads to an increased heat loss by convection radially outwards.

In measuring devices of the invention, the second sections 5, 29, 35, 41, 45, 51, 57 can be units in their own right, connected as e.g. shown in FIG. 1 with the first and third sections 3, 7 by welds. Alternatively, the second sections 5, 29, 35, 41, 45, 51, 57 can be integrated with the first and/or the third sections as a single unit.

The regions of reduced wall thickness, or the grooves, as the case may be, can be produced e.g. by machining on a lathe.

By the second sections 5, 29, 35, 41, 45, 51, 57, it is achieved that even when the first section 1 is exposed at the location of measurement to very high temperatures, e.g. 150° C., the electronic components 19 in the third section 7 are protected against overheating. If the first section 1 is exposed to a temperature of 150° C., then a groove with a width of a bit more than a centimeter is sufficient to assure that the electronic components 19 do not exceed a maximum temperature of 85° C., a temperature given by most component manufacturers as an upper temperature limit for the use of electronic components.

A great advantage of the measuring devices of the invention is that they can be used at high temperatures and can, at the same time, withstand high mechanical loads perpendicular to the longitudinal axis L of the housing 1, e.g. loads of 1000 N. Consequently, the measuring devices are usable in a wide variety of situations.

1-8. (canceled)

9. A measuring device, comprising: a housing, which has a first section, on which a means for the securement of the housing at a measurement location is provided, which has a second section, which borders on the first section, and which has a third section, which borders on the second section and in which electronic components are located, wherein:
said second section is constructed such that, in the presence of a temperature difference between an environment of said first section and an environment of said third section, a small flow of heat flows through said second section, parallel to a longitudinal axis of the housing, and
a wall of said second section has at least one region of reduced wall thickness.

10. (canceled)

11. The measuring device as claimed in claim 9, wherein:
at least one peripheral groove is provided in the wall of said second section.

12. The measuring device as claimed in claim 9, wherein:
a plurality of regions of reduced wall thickness are arranged next to one another in the wall of said second section, separated from one another by webs.

13. The measuring device as claimed in claim 12, wherein:
the wall of said second section has a plurality of layers of neighboring regions of reduced wall thickness arranged one on top of the other; and
neighboring regions of one layer are separated from one another by webs and webs of neighboring layers are offset with respect to one another.

14. The measuring device as claimed in claim 9, wherein:
a support of insulating material is arranged within said housing in the region of said second section for increasing the mechanical strength of said housing relative to loads perpendicular to the longitudinal axis of said housing.

15. (canceled)

16. The measuring device as claimed in claim 11, wherein:
a plurality of peripherally extending grooves are provided in the wall of said second section;
the grooves are arranged alternatingly on an inner side of the wall and an outer side of the wall.
